(19) United States
(12) Patent Application Publication
(10) Pub. No.: US 2018/0233868 A1
(43) Pub. Date: Aug. 16, 2018

(54) Socket for Connecting a Plug Connector in the External Area of a Motor Vehicle

(71) Applicant: Erich Jaeger GmbH & Co. KG, Friedberg (DE)

(72) Inventor: Gary Hachadorian, Frankfurt am Main (DE)

(21) Appl. No.: 15/894,827

(22) Filed: Feb. 12, 2018

(30) Foreign Application Priority Data
Feb. 15, 2017 (DE) 10 2017 103 025.5

(51) Int. Cl. H01R 27/00; H01R 13/627; H01R 13/447; H01R 13/512; H01R 12/71

(52) U.S. Cl. CPC H01R 27/00; H01R 13/6273; H01R 13/73; H01R 13/512; H01R 12/718; H01R 13/447

(57) ABSTRACT

A socket for connecting a plug connector in the external area of a motor vehicle to a socket housing is described, in which a first plug receiving opening is designed with electrical contacts for plugging in a plug connector and making an electrical connection, and having a first cover, which is hinge-connected to the socket housing and which in the closed position thereof completely seals off the first plug receiving opening and is spring-loaded in the closing direction, wherein a first locking mechanism is provided, which increases the retaining force of the first cover in the closed position thereof and which comprises a first retaining element, which yields to a return force and applies an additional retaining force to the first cover in the closed position thereof in the closing direction. It is also provided that a second plug receiving opening is formed in the socket housing, having a data network connection for plugging in a data network plug connector and for establishing a data network connection, and that a second cover is provided, which is hinge-connected to the socket housing and which in the closed position thereof completely seals off the second plug receiving opening and is spring-loaded in the closing direction.

### FIELD OF THE INVENTION

The invention relates to a socket for connecting a plug connector in the external area of a motor vehicle having a socket housing, in which a first plug receiving opening having electrical contacts is designed for plugging in a connector and making an electrical connection to the electrical network (on-board network) of the motor vehicle. A first cover is hinge-connected to the socket housing, which in its closed position completely seals off the first plug receiving opening and is spring-loaded in the closing direction, wherein a first locking mechanism is provided, which increases the retaining force of the first cover in its closed position and which comprises a first retaining element, which applies an additional retaining force to the first cover in the closing direction in its closed position.

### BACKGROUND OF THE INVENTION

Such a plug connector is known from EP 2 603 954 B1. Generally, the covers that are hinge-connected to the socket housing are mounted on a hinge and spring-loaded in the closing direction by means of a yoke spring. For this reason, the moment acting on the lid in the closing direction in the open position is greater than in the closed position of the lid. The spring force of the yoke spring in a wholly or partially open position of the cover must be exactly large enough that the lid closes again when released. In practice, especially when the sockets are used in agriculture or in trucks, this results in problems with sealing, since trucks and agricultural equipment often become extremely dirty in use and may need to be cleaned using high-pressure cleaners. It can occur that, due to the force of the water jet the cover is lifted out of its closed position, allowing moisture to intrude into the contact area of the socket, which can cause short circuits during subsequent usage. To improve the seal of the socket between the closed lid and the wall of the plug receiving opening, the retaining force of the cover in a previously defined closed position must be increased. To supply this (additional) holding force the locking mechanism comprises a retaining element that yields under a return force and applies an additional retaining force to the lid in the closing direction in its closed position. After this retaining force is overcome, the retaining element escapes into a guide provided for it. After the movement of the cover or of a separate locking clip, which can be part of the locking mechanism and engages on the cover, out of the closed position, no holding force is any longer exerted on the cover in the closing direction of the cover. This retaining mechanism is proven in practice and is increasingly used in so-called ISOBUS sockets, for example in agriculture or trucks.

Applications in agriculture or trailers of trucks increasingly require the use of data network connections between the motor vehicle and trailer, or the connected functional unit. The installation of additional sockets for such a data network connection is expensive however, and often complicated by a shortage of space. Since the network transmission technology is very susceptible to interference, the network connection itself must also be reliably protected, in particular against the ingress of moisture.

### SUMMARY

It is accordingly an object of the invention to provide a trailer socket, which in addition to providing an electrical connection to a vehicle without increasing the dimensions (e.g. of a standard ISOBUS socket).

It is a further object of the invention to provide a data network connection having a separately controllable cover that completely seals the plug connector opening for the data network connection.

In this regard, the present disclosure proposes a socket for connecting a plug connector in the external area of a motor vehicle, having a socket housing in which a first plug receiving opening having electrical contacts is designed for plugging in a plug connector and for producing an electrical connection, and having a first cover, which is hinge-connected to the socket housing and which in the closed position thereof completely seals off the first plug receiving opening and is spring-loaded in the closing direction, wherein a first locking mechanism) is provided, which increases the retaining force of the first cover in the closed position thereof and which comprises a first retaining element, which yields under a return force and applies an additional retaining force to the first cover in the closed position thereof in the closing direction. It is provided that a second plug receiving opening is designed in the socket housing with a data network connector, in particular an Ethernet connector, for plugging in a data network plug connector and establishing a data network connection. A second cover is also provided, which is hinge-connected to the socket housing and which in its closed position completely seals the second plug receiving opening and is spring-loaded in the closing direction. For the second cover, a second locking mechanism is provided, which increases the holding force of the second cover in its closed position and comprises a second retaining element which yields under a return force and applies an additional retaining force in the closing direction to the second cover in its closed position, wherein the first cover and the second cover are adjustable independently of each other between their closed position and their open position. This means that due to the second plug receiving opening, a data network connector sealed in a similar manner to the first plug receiving opening is proposed in the same socket and is no larger in terms of the dimensions of the base plate of the socket housing.

In addition to the connection of the purely electrical network of motor vehicle and trailer (on-board network), in this manner a data network connection to the trailer or to the corresponding functional unit can also be implemented via the same socket housing. Compared to a socket housing without a data network connector, according to the invention the socket housing is not increased in terms of the dimensions of the base plate. This allows the socket with data network connector to be installed instead of a socket without data network connector in the same assembly space. At the same time a high degree of water-tightness is achieved, both for the purely electrical connection as well as the data network connection. This is of particular importance, for example, in agriculture or in trucks with special trailers, for example, Unimogs, in which the trailers are increasingly being provided with data network connections to perform the necessary tasks, and which are often heavily soiled after use. The high degree of water-tightness allows the vehicles to be cleaned even with high-pressure water jet devices without the risk of the first and second covers being lifted by the high water pressure or of moisture entering the electrical or electronic connection between motor vehicle and trailer. A preferred example of the socket according to the invention is an ISOBUS socket.

### BRIEF DESCRIPTION OF THE DRAWINGS

FIG. 1 shows an embodiment of the socket according to the invention in a three-dimensional front view, with a first plug connector receptacle and a first locking mechanism comprising a locking clip in the closed position of the first cover and of the locking clip, and with a second plug connector receptacle and a second locking mechanism accommodated in the second cover in the open position of the first cover.

FIG. 2 shows the embodiment as shown in FIG. 1 in three-dimensional rear view with a sub-assembly, which comprises connection elements and carries the second plug connector receptacle and the second cover.

FIG. 3 shows a partial sectional view of FIG. 1 through the second plug connector receptacle and the second cover in a horizontal section.

FIG. 4 shows a three-dimensional rear view of the sub-assembly as shown in FIG. 2 with an assembly cover carrying the connection elements.

FIG. 5 shows a three-dimensional rear view of the sub-assembly as shown in FIG. 4 without the assembly cover.

### DETAILED DESCRIPTION

Before describing a preferred embodiment according to the proposal in detail with reference to the drawings, different aspects of the proposal are addressed.

Motor vehicle within the meaning of this description is defined as both a driven motor vehicle (e.g. in the sense of a towing vehicle) and a non-driven motor vehicle (e.g. a trailer). A trailer is defined as both a wheeled vehicle, which couples to the towing vehicle and is pulled along behind the towing vehicle by the latter, and as a vehicle structure fixed to the towing vehicle but not equipped with wheels (for example a salt spreading device, a plough or similar).

According to a preferred embodiment of the proposed socket according to the invention, the socket housing can be formed in at least two parts, a first part of the socket housing containing a base plate having the first plug receiving opening, the first cover, the first locking mechanism, at least two fixing holes, for example for screwing the socket onto a mounting surface of the motor vehicle, and a recess. A second part of the socket housing can then contain the second plug receiving opening, the second cover, a base plate part which fills the recess in the first part and a sub-assembly, wherein the sub-assembly can be connected to the rear of the base plate, i.e. on the opposite (socket-connector) side to the first and second connector receiving openings. In particular, the base plate of the first part of the socket housing and the base plate part of the second part of the socket housing can comprise a system-side flange, which is seated and supported on a mounting surface (e.g. the vehicle body) of the motor vehicle when a socket is mounted on the motor vehicle. The flange usually surrounds a connection aperture in the mounting surface, in which socket connector plugs can be connected at the rear (on the socket-side) to the connecting elements of the sub-assembly. By virtue of the sub-assembly comprising a part of the base plate and preferably also a part of the system-side flange, the—limited—space on the insertion side of the socket (plug-connector side with the first and second plug connector receiving opening) can be better utilized. Thus, there is more space available for the second plug receiving opening and the second cover with the second locking mechanism.

The sub-assembly can preferably contain a circuit board, which carries the contacts of the first plug connector receiving opening and/or the data network connection of the second plug connector receiving opening. According to the invention, other electrical and/or electronic components can also be arranged on the circuit board, for example for implementing the data network connection. The subassembly can therefore form an assembly with the circuit board, for example as a kind of contact carrier insert, which can be connected at the rear of the base plate of the first socket part and implements the placement of electrical and/or electronic components on the socket. This simplifies the assembly and mounting of the socket during vehicle manufacture. The sub-assembly with the electrical and/or electronic components can also be easily replaced in an unmounted socket.

To fix it in place, according to the invention the sub-assembly can be screwed onto the base plate, for example at three or more points, and/or encapsulated as a whole unit. By means of a sub-assembly, which can be screwed to the base plate for example, the insertion forces due to inserting plug connectors into the first and second plug receiving openings can be absorbed and an effective seal obtained via a seal, which is arranged between the sub-assembly and the system side of the base plate. At least three screw fixings can preferably be provided, one of the screw fixings being arranged on the opposite side of the sub-assembly to the base plate. The other two screw fixings can be arranged on an edge of the sub-assembly facing the base plate part. Preferably, connection lines from a centre of the sub-assembly (e.g. a centre point of the sub-assembly) to each of the screw fixings can intersect at an angle of 120°+/−20°. It is also advantageous if the length of the connecting lines from the centre of the sub-assembly to each of the screw fixings is approximately the same, i.e. preferably varies by no more than 20% or 30%. This enables a uniform screw connection to be implemented. In addition, or as an alternative to screw fastenings, the sub-assembly can also be encapsulated with the base plate. This enables a mechanically durable and waterproof solution to be easily implemented.

In one embodiment, the base plate of the first part of the socket housing and the base plate part of the second part of the socket housing can according to the invention have a system-side flange, whose surface is oriented perpendicular to a frontal surface and forms an edge of the socket housing for attachment to a mounting surface. The surface of the flange that is oriented perpendicular to a frontal surface is in other words to be understood as an imaginary plane surface of the socket housing, on which the first plug receiving opening with the first cover and with the first locking mechanism and the second plug receiving opening with the second cover and the second locking mechanism are assembled, and which extends perpendicular to the surface of the flange. This system-side flange ensures a mechanically stable structure of the socket housing and is designed to support the socket housing on the mounting surface around its entire edge and to enclose a (socket-side) connection aperture to provide the cable entry in the mounting surface. Mounting holes for fixing the socket housing to the mounting surface of the motor vehicle are preferably incorporated in the system-side flange (the base plate) of the first part of the socket housing, e.g. for the passage of screws that are screwed to the mounting surface. According to the invention therefore, the base plate of the first part is fastened to the mounting surface and the base plate part of the second part with the sub-assembly is fastened to the base plate of the first part. This facilitates the mounting of the socket housing on the motor vehicle, because the socket is fully pre-assembled and can be mounted as a part of the motor vehicle. According to the invention the socket housing preferably comprises a rectangular or square basic shape (and therefore base plate), wherein the corners may be rounded. The mounting holes are preferably formed in the corners of the base plate.

The sub-assembly can form, according to one embodiment of the invention, an assembly body with the base plate part, which forms the system-side flange and also carries the second plug receiving opening, the second cover and the second locking mechanism, and with a receiving space for electrical and/or electronic components, which in particular receives and if possible fixes the circuit board in place, and can also comprise an assembly cover that contains connecting elements for connecting to the vehicle electrical system and the data network of the motor vehicle. The connecting elements can mechanically form parts of plug connections and/or fix them in place. According to the invention the assembly body and the assembly cover are connected to each other in a watertight manner, e.g. by adhesive bonding, encapsulation and/or by means of an interstitial seal.

In a further development of this embodiment, the module cover can have a flattened area in a region adjacent to the base plate part, or more precisely adjacent to the system-side flange of the base plate part, which together with the base plate forms the system-side flange. In this region, according to the invention the sub-assembly does not project beyond the rear edge of the system-side flange, so that an aerial contact with the mounting surface can be obtained there. The system-side flange (or the surrounding edge of this flange), preferably has a width of at least 2 mm or of at least 3 mm, possibly even up to at least 6 mm. This secures the contact between the peripheral edge of the system-side flange on the mounting surface and provides support for it. According to the invention a lower overall height of the socket is given only in the region of the connection aperture of the mounting surface, into which higher structures of the sub-assembly can then enter. The connection aperture is located preferably completely within the system-side flange, to prevent damage to the cables passing through the connection aperture.

According to the invention, at least one first connector element can be formed on the assembly cover for the socket-side connection to the electrical system of the motor vehicle (on-board network) and at least one second connector element for the socket-side connection to the data network of the motor vehicle. The assembly cover preferably comprises two first connector elements and two second connector elements. The first connector element or elements are connected to contacts of the first (plug-side) plug receiving opening, and the second connector elements are connected to contacts of the second (plug-side) plug receiving opening. The first plug receiving opening can be preferably implemented as an ISOBUS connector and the second plug receiving opening as, for example, a 4-pin Ethernet connector (Fast Ethernet). The second plug receiving opening can be formed by a 4-pin equipment box with socket contacts for a push-pull plug connector system. The plug insertion direction is preferably aligned perpendicular to the plane defined by the flat areas of the base plate. This means that the direction of insertion is therefore also axial with respect to the central axis of the first plug receiving opening. In other words, the central axes of the first and the second plug receiving opening run parallel to each other and stand vertically on the base plate of the socket.

The second connecting elements of the assembly cover can be designed as entry holes for plug connectors fixed on the board, for example. 2-pin or 4-pin plug connectors, such as M12 connectors. The plug connector can comprise an external thread, with which the connector is held in a sealing manner (i.e., for example by means of an interstitial seal) in the entry hole of the assembly cover by a lock nut. Additionally, or alternatively, the plug connector can also be encapsulated with the assembly cover in order to mechanically fix and seal the connector in the assembly cover.

According to a preferred embodiment according to the invention, the second plug receiving opening with the second cover can be arranged next to the first plug receiving opening, preferably in such a way that the pivot axes of the first and the second cover run parallel. In this case the central axis of the first connector receiving opening and the central axis of the second connector receiving opening are situated approximately in the centre of the base plate of the socket, in relation to a direction perpendicular to the pivot axes of the first and second cover. Approximately in the centre means that the distance between each of the central axes of the first and the second plug receiving openings from the centre is less than 20%, preferably less than 10%, of the length of the socket in this direction (perpendicular to the pivot axes). This means the second plug receiving opening and the second cover are situated between the pivot axis of the first cover and the pivot axis of the locking clip.

In a preferred embodiment the second retaining element of the second locking mechanism is moveably accommodated in a guide having an open and a closed end and with a guide hole, which has an internal diameter corresponding to the diameter of the second retaining element. To generate a return force for the second retaining element, a spring is held in the guide hole, which spring is supported at the closed end of the guide hole and at the opposite end impinges on the second retaining element, which is also received in the guide hole. To interact with the second retaining element a first receiving opening is formed in the second cover, which in the closed position of the second cover is positioned in front of the guide hole in such a way that the second retaining element partially enters the first receiving opening. In this position the second retaining element generates an additional retaining force, which counteracts any movement of the second cover out of its closed position.

In a further development of this inventive idea, a second receiving opening can optionally be formed in the second cover, which in the open position of the second cover is positioned in front of the guide hole in such a way that the second retaining element partially enters the second receiving opening. This measure enables the second cover to be held open against its return force exerted by the cover spiral spring and facilitates the insertion of the data network connector. Because the data network connector can be easily mechanically damaged, by keeping the second cover open at least during the connecting process, the data network connection is mechanically relieved.

According to the invention the guide can be accommodated between the two cover holders of the second cover, wherein the axis of the guide hole extends in the direction of the axis of the second plug receiving opening. This means that the guide with the guide hole can be arranged vertically on the base plate or the base plate part, only taking up a very small amount of space on the base plate. This means that the guide of the second locking mechanism can also be integrated into the second part of the socket housing. The second retaining element can preferably be designed as a ball.

In an alternative embodiment of the second locking mechanism the second retaining element of the second locking mechanism can be designed as a flexible element, which is fixed to the socket housing and comprises a projection that in the closed position and/or in the open position of the second cover engages in a receiving opening, i.e. possibly one opening each for the closed position and the open position, which is formed in the second cover and corresponds to the shape of the projection, when the cover is in its closed position and/or open position. Upon opening the cover the projection of the flexible element is then pushed out of the receiving opening by deformation of the flexible element, for which purpose a corresponding escape chamber is provided in the socket. The second retaining element designed as a flexible element can, for example, be a kind of spring plate, the one end or both ends of which are fixed in the socket housing. The projection can be formed on the spring plate, for example in the middle or at a suitable position, by the spring plate being suitable irreversibly deformed, e.g. by bending. This enables, for example, a semi-circular curved projection to be created, which engages in the suitably arranged receiving openings in the second cover when the second cover reaches a closed position, and possibly its open position as well. This embodiment of the second locking mechanism can in principle be arranged at the same position as the previously described second locking mechanism, i.e. between the two cover holders bearing the pivot axis. Alternatively, the retaining element of this additional embodiment of the locking mechanism can also be fixed to the side of the cover, for example on the cover holder, and engage with receiving openings arranged on the sides of the covers.

This alternative locking mechanism, described previously for the second cover, can be used in a technically comparable implementation according to the invention with the first cover and the first plug receiving opening also.

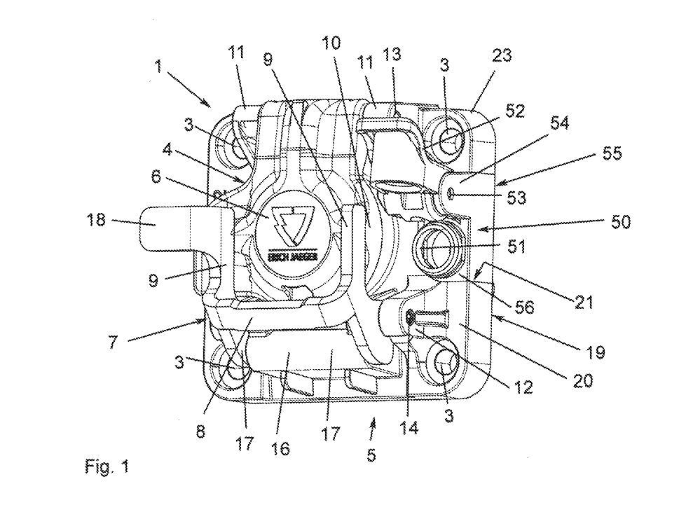

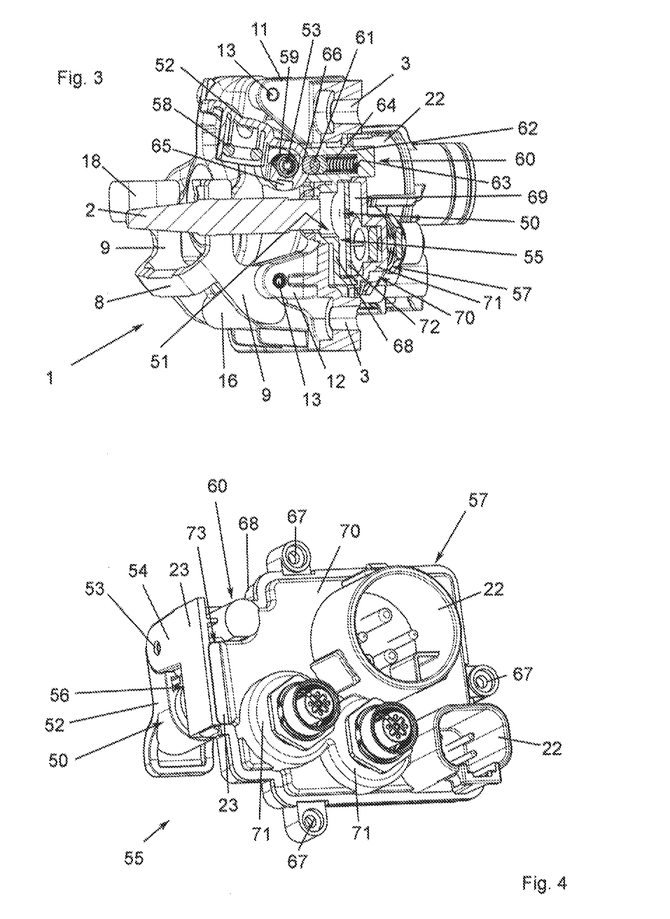

Further features, advantages and application possibilities of the invention are also obtained from the following description of exemplary embodiments and from the drawings. In these, all features described and/or graphically depicted form the subject matter of the present invention either in themselves or in any combination. Referring now to FIG. 1, the socket 1 shown is used for connecting a first plug connector, not shown here, to the electrical circuit of a vehicle and a second connector 2 shown in FIG. 3 to a data network of the vehicle. The socket 1 is typically mounted on the exterior of a vehicle and is used to connect trailers or other electrical consumers to the electrical circuit of the motor vehicle. In addition, the trailer or other electrical consumer, or even another functional element, can be connected to a data network, in particular a high-speed Ethernet. By means of screws, which are not shown, the socket 1 can be held by screws or screwed onto the motor vehicle through mounting holes 3, wherein the mounting holes 3 are located in corners of the socket 1.

In accordance with a preferred embodiment shown here, the socket housing 5 has a rectangular or square design and preferably comprises side lengths of approximately 91.5 mm (in the direction along the pivot axes 13, 53 of the covers 6, 52), and of approximately 86.5 mm (transverse to the direction along the pivot axes 13, 53 of the covers 6, 52), up to a maximum of approximately 91.8 mm×86.8 mm. The distance between each of two mounting holes is preferably approximately 71.5 mm (in the direction along the pivot axes 13, 53 of the covers 6, 52) and approximately 66.3 mm (transverse to the direction along the pivot axes 13, 53 of the covers 6, 52), wherein possible tolerances may be +/−10%.

In principle, the concept of the socket according to the invention can also be implemented in other sockets, in particular larger sockets. The particular advantages are particularly useful, however, in these relatively small dimensions of the socket 1 according to the invention, in which in spite of the small dimensions a connection both to the (electrical) on-board network of the motor vehicle and to a data network (Ethernet) of the motor vehicle can be implemented.

The present invention is particularly suitable for use in towing motor vehicles, which are used in the field of agriculture or construction machinery, in order that they can be connected to trailers or other machines that have their own power circuit. To provide the electrical supply to the trailers or machines, these are provided with a plug for connecting to the on-board power supply (possibly with a second connector for connecting to the data network), which can be inserted into the socket 1.

Hereafter the known elements of the socket 1 for connection to the electrical system of the motor vehicle (on-board network) are described first.

In FIG. 1, the socket 1 is shown in a state in which no plug is inserted into the socket 1. A first plug receiving opening 4 provided for inserting a first plug connector is completely sealed with a first cover 6, which is hinge-connected to the socket housing 5. The first cover 6 is spring-loaded in the closing direction by means of a standard cover spiral spring 15, and additionally secured by a locking mechanism 7, which increases the retaining or clamping force of the first cover 6 in its closed position.

In addition, the locking mechanism 7 comprises a locking clip 8 having two arms 9, each overhanging one edge of the first cover 6, which in the closed position of the first cover 6 of the locking clip 7 are seated on a pressing surface 10 of the first cover 6, in order to exert the additional retaining force provided according to the invention on the first cover 6.

The locking clip 8 is hinge-connected to the socket housing 5, similarly to the first cover 6, wherein the pivot axis 13 of the first cover 6 and the pivot axis 14 of the locking clip 8 are spaced apart from each other and oriented in parallel, so that the pivot direction of the cover 6 and of the locking clip 8 lie in parallel planes to each other. The first plug receiving opening 4 is arranged between the first and the second pivot axis 13, 14. This results in the situation that the first cover 6 and the arms 9 of the locking mechanism 7 are rotated in different (contrary) directions of rotation to the first plug receiving opening 4.

The first cover 6 is hinge-connected via a cover holder 11, connected integrally to the socket housing 5, and the locking clip 8 is hinge-connected via a clip holder 12, connected integrally to the socket housing 5, to the socket 1. Cover holder 11 and clip holder 12 are located on opposite sides of the plug receiving opening 4 and are arranged in such a way that the pivot axes 13, 14 for the first cover 6 and the locking clip 8 are arranged in parallel in the manner described above. This means that the first cover 6 and the locking clip 8 are folded over the connector receiving opening 4 from different sides.

The locking clip 8 is not spring-loaded either in the direction of its open position (not shown in the figures) or in the direction of its closed position (shown for example in FIG. 1).

The arms 9 of the locking clip 8, which are designed straight or planar on their side facing the first cover 6, come to rest in the closed position of first cover 6 and locking clip 8 on rounded pressing surfaces 10 of the first cover 6, wherein the pressing surfaces 10 are arranged in the centre of the first connector opening 4 in a direction perpendicular to the pivot axes 13, 14 of first cover 6 and locking clip 8, so that the arms 9 in the closed position of locking clip 8 in the centre of the first cover 6 exert a uniform contact pressure exercise and achieve, or secure, a reliable sealing effect.

If locking clip 8 is opened, the first cover 6 can be opened against its spring loading force exerted by a cover spiral spring 15. This releases the first plug receiving opening 4 with the contacts (not shown) arranged therein for plugging in the connector (not shown). In order to seal the first connector receiving opening 4 in the closed position of the first cover 6, an O-ring seal is arranged in the first cover 6 in the standard manner, which interacts with the front wall of the first connector receiving opening 4 as a sealing surface in the closed position of the first cover 6.

In order to apply an additional retaining force to the first cover 6 in its closed position and thus to improve the effectiveness of the seal, the additional locking mechanism 7 is provided, which in the embodiment described here by way of example comprises the locking clip 8, which is hinge-connected to the clip holder 12. Furthermore, the locking mechanism 7 comprises a guide 16 with two guide holes (not shown), arranged axially on opposite sides of the guide 16, the axes of which preferably extend parallel to the pivot axis 14 of locking clip 8.

In each of the guide openings, designed in the manner of a blind hole, are accommodated one pressure spring each and a ball as the first retaining element, in such a way that the ball, used as a first retaining element, can be pressed into the guide hole against a return force of the pressure spring. In the installed condition of the locking clip 8, the first retaining elements are braced against the return force of the spring on an (inner, facing the guide 16) wall surface or guide surface 17 of the locking clip 8. In the closed position of the locking clip 8, receiving openings (not shown) provided in the wall surface 17 are located in front of each of the guide holes and allow a partial emerging of the first retaining elements from the guide holes into the receiving openings.

To this end, in the closed position of the locking clip 8 and thus also of the first cover 6, the guide holes and receiving openings are arranged coaxially, the diameter of the receiving openings is smaller than the diameter of the guide holes, so that the first retaining elements cannot completely emerge from the guide hole. Nevertheless, the balls (as first retaining elements) interact with the inside wall or edge of the receiving holes, so that in the closed position of the locking clip 8 an additional retaining force is exerted on the locking clip 8 or first cover 6, by virtue of the arms 9 resting on the pressing surfaces 10 of the first cover 6 and in doing so, pressing the O-ring seal arranged in the cover 6 onto the front wall of the plug receiving opening.

This is already described in detail in EP 2 603 954 B1. The mode of action for generating the retaining force is described here in a similar way later for the second cover 52 for closing the second connector receiving opening 51 of the connector 50 for the data network and shown in FIG. 3. The designs shown there are also correspondingly valid here.

To overcome the retaining forces applied by the first retaining elements, one of the arms 9 of the locking clip 8 comprises a pulling surface 18 which stands clear of the side of the first cover 6, which can be easily reached behind with a finger in order to turn the locking clip 8 away from the first cover 6. In doing so the additional retaining force of the first retaining elements is overcome. The pulling surface 18 thus stands clear of the arm 9 in a sideways direction, and namely in a direction facing away from the first cover 6, which runs parallel to the pivot axes 13, 14 of the first cover 6 and the locking clip 8. The pulling surface 18 is preferably approximately centred between the pivot axis 13 of the first cover 6 and the pivot axis 14 of the locking clip 8.

On the other hand, the arm 9 of the locking clip 8 extending on the other side of the first cover 6 (in the plan view of the plug connection side of the socket shown in FIG. 1 this is the right arm 9), has according to the invention no pulling surface. Rather, this (preferably right-hand) arm 9 of the locking clip 8 is designed in such a way that the arm 9 which is not fitted with a pulling surface does not protrude over the edge of the first cover 6. What is meant by this is that the overhang of the arm 9 over the edge of the cover 6 along the pivot axes 13, 14 is less than its width (extending in the direction of the pivot axes 13, 14). This is the means by which in accordance with the invention the space is created for the data network connection 50.

According to the invention therefore, the second plug receiving opening 51 with the second cover 52 is arranged next to the first plug receiving opening 4, preferably approximately centrally between the pivot axis 13 of the first cover 6 and the pivot axis 14 of the locking clip 8. The pivot axis 53 of the second cover 52 and the pivot axis 31 of the first cover 6 are preferably parallel. The second cover 52 is mounted about its pivot axis 53 in a cover holder 54.

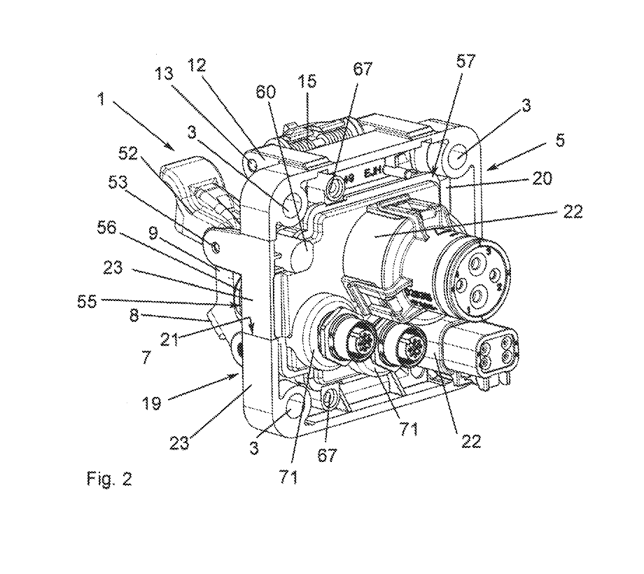

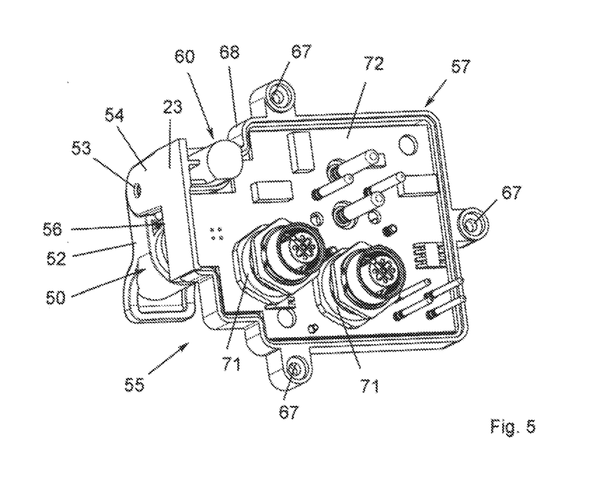

In the particularly preferred embodiment described here, the socket housing 5 is formed of two parts. A first part 19 of the socket housing 5 comprises a base plate 20 with in particular the first plug receiving opening 4, the first cover 6, the first locking mechanism 7, at least two fixing holes 3 and a recess 21. A second part 55 of the socket housing 5 comprises the second plug receiving opening 51, the second cover 52, a base plate part 56 filling the recess 21 in the first part 19 and a sub-assembly 57. The sub-assembly 57 of the second part 55 of the socket housing 5 shown in FIG. 4 can be connected at the rear to the base plate 20 of the first part 19 of the socket housing 5, as the view according to FIG. 2 shows.

This means that the data network connection 50 is therefore part of a separate (second) part 55 of the socket housing 5. This modular structure allows, as already described, an optimized space utilization, which facilitates the arrangement of the data network connection 50 close to the edge of the socket housing 5 and allows a simple placement of the connection contacts (not shown in the Figures for the sake of clarity).

As shown in FIG. 3, the second cover 52 comprises an O-ring seal 58, which is seated on the upper edge of the second plug receiving opening 51 when the second cover 52 is closed and is pressed in the direction of the closed position by means of a cover spiral spring 59. In this closed position a second locking mechanism 60 exerts an additional retaining force on the second cover 52.

The second locking mechanism 60 has as a second retaining element 61 a ball, which is movably accommodated in a guide 62 having an open and a closed end and with a guide hole 63. The guide hole 63 has an inside diameter corresponding to the diameter of the ball 61 (second retaining element). As the element generating the return force of the ball 61 (second retaining element), a spring 64 is received in the guide hole 63, which is supported at the closed end of the guide hole 63 and at the opposite end impinges on the second ball 61 (second retaining element) which is also received in the guide hole 63.

In the second cover 52 a first receiving opening 65 is formed, which in the closed position of the second cover 52 is positioned in front of the guide hole 63 in such a way that that the second retaining element 61 partially enters the second receiving opening 65. This results in a blocking of the second cover 52 against twisting that can only be lifted by the second retaining element 61 being pressed back into the guide hole 63 against the restoring force of the spring 64. The force required for this is the additional retaining force generated by the second retaining element 61.

In the exemplary embodiment shown in FIG. 3, in the second cover 52 a second receiving opening 66 is additionally formed, which in the open position of the second cover 52 is positioned in front of the guide hole 63 in such a way that the second retaining element 61 partially enters the second receiving opening 66. This position is shown in FIG. 3 and indicated by showing two mutually offset balls to represent the ball that is acting as the second retaining element 61. The use of this optional feature means that the second cover 52 is also held in its open position against the return force of the cover spiral spring 59 and allows the insertion of the data network plug 2 without the possibility of the data network connection 50 being mechanically damaged by a second cover 52, which presses against the data network plug 2. The handling is also improved if after opening, the second cover 52 remains in its open position and does not additionally need to be grasped during the insertion process.

FIG. 2 shows a rear view of the socket 1 with the first part 19 and the second part 55 of the socket housing 5. The second part 55, with the base plate part 56 that fills the recess 21 of the first part 19 and the sub-assembly 57, is screwed into the base plate 20 by being screwed into screw fixings 67.

FIGS. 4 and 5 show the second part 55 of the socket housing 5 that comprises the base plate part 56 and the sub-assembly 57. The sub-assembly 57 comprises an assembly body 68, which integrally forms the base plate part 56 and a receiving space 69 for electrical and/or electronic components (FIG. 5). The receiving space 69 is closed by mean of an assembly cover 70, which comprises first connection elements 22 for connecting to the vehicle electrical system (on-board network) and second connection elements 71 for connecting to the data network of the motor vehicle (FIG. 4).

As shown in FIG. 5, in the receiving space 69 of the sub-assembly 57 a circuit board 72 is arranged, which carries the contacts of the first plug receiving opening 4 and/or the data network connection of the second plug receiving opening 51. The contacts and the data network connection protrude through the first and second connection elements 22, 71 of the module cover and are used to connect the socket 1 to the motor vehicle.

It can be identified in particular from FIG. 2 that the base plate 20 of the first part 19 of the socket housing 5 and the base plate part 56 of the second part 55 of the socket housing 5 comprise a system-side flange 23, the surface of which is oriented perpendicular to a frontal surface and forms an edge around the perimeter of the socket housing 5 for resting on a mounting surface. In order to obtain a broader contact on the mounting surface, the assembly cover 70 comprises a flattened area 73 in a region adjacent to the base plate part 56, which together with the base plate part 36 forms the system-side flange 23.

What is claimed is:

1. A socket for connecting a plug connector in the external area of a motor vehicle, having
a socket housing in which a first plug receiving opening having electrical contacts is designed for plugging in a plug connector and for producing an electrical connection, and
a first cover hinge-connected to the socket housing, said first cover completely sealing off the first plug receiving opening in its closed position and being spring-loaded in the closing direction,
wherein a first locking mechanism is provided increasing the retaining force of the first cover in its closed position, said first locking mechanism comprising a first retaining element, which yields under a return force and applies an additional retaining force to the first cover in its closed position in the closing direction,
wherein a second plug receiving opening is formed in the socket housing having a data network connection for plugging in a data network plug connector and for establishing a data network connection, and
wherein a second cover is provided hinge-connected to the socket housing, said second cover completely sealing off the second plug receiving opening in its closed position and being spring-loaded in the closing direction,
wherein a second locking mechanism is provided increasing the retaining force of the second cover in its closed position, said second locking mechanism comprising a second retaining element, which yields under a return force and applies an additional retaining force to the second cover in its closed position in the closing direction,
wherein the first cover and the second cover are adjustable independently of each other between their closed position and their open position.

2. The Socket according to claim 1, wherein the socket housing is constructed in at least two parts,
a first part of the socket housing containing a base plate having the first plug receiving opening, the first cover, the first locking mechanism, at least two fixing holes and one recess, and
a second part containing the second plug receiving opening, the second cover, a base plate part which fills the plug receiving opening in the first part, and a sub-assembly, which sub-assembly can be connected to the base plate at the rear.

3. Socket according to claim 2, wherein in the sub-assembly a circuit board is arranged, which carries the contacts of the first plug receiving opening and/or the data network connection of the second plug receiving opening.

4. Socket according to claim 2, wherein the sub-assembly is screwed to and/or encapsulated with the base plate.

5. Socket according to claim 2, wherein the base plate of the first part of the socket housing and the base plate part of the second part of the socket housing comprise a system-side flange, the surface of which is oriented perpendicular to a frontal surface and forms one edge of the socket housing (5) for resting against a mounting surface.

6. Socket according to claim 5, wherein the sub-assembly forms an assembly body with the base plate part and with a receiving space for electrical and/or electronic components and comprises an assembly cover, which comprises connection elements for connecting to the vehicle electrical system and to the data network of the motor vehicle.

7. Socket according to claim 6, wherein in a region adjacent to the base plate part the assembly cover comprises a flattened area, which together with the base plate part forms the system-side flange.

8. Socket according to claim 6, wherein on the assembly cover at least one first connecting element for the socket terminal-side connection to the electrical system of the motor vehicle and at least one second connecting element for the socket connector-side connection to the data network of the motor vehicle are formed.

9. Socket according to claim 1, wherein the second plug receiving opening with the second cover is arranged next to the first plug receiving opening, between the pivot axis of the first cover and the pivot axis of the locking clip.

10. Socket according to any of the previous claims, wherein
the second retaining element of the second locking mechanism is movably accommodated in a guide having an open and a closed end and with a guide hole, which has an internal diameter corresponding to the diameter of the second retaining element,
a spring is accommodated in the guide hole to act as an element that generates a return force of the second retaining element, said spring being supported at the closed end of the guide hole and at the opposite end impinging on the second retaining element, which is also accommodated in the guide hole, and
in the second cover a first receiving opening is formed, which in the closed position of the second cover is positioned in front of the guide hole in such a way that the second retaining element partially enters the first receiving opening.

11. Socket according to claim 10, wherein in the second cover a second receiving opening is formed, which in the open position of the second cover is positioned in front of the guide hole in such a way that the second retaining element partially enters the second receiving opening.

12. Socket according to claim 10, wherein the guide is received between two cover holders of the second cover, the axis of the guide hole extending in the direction of the axis of the second plug receiving opening.

13. Socket according to any one of claim 10, wherein the second retaining element is implemented as a ball.

14. Socket according to any of claim 1, wherein the second retaining element of the second locking mechanism is designed as a flexible element that is fixed to the socket housing and comprises a projection, which in the closed position and/or in the open position of the second cover engages in a receiving opening corresponding to the shape of the projection, which is formed in the second cover, when the second cover is in the closed position and/or open position thereof.
